(19) United States
(12) Patent Application Publication
(10) Pub. No.: US 2004/0207501 A1
(43) Pub. Date: Oct. 21, 2004

(54) Coil member, method and system for manufacturing same, tooth member, core, and rotary electric machine

(76) Inventors: Takahiro Souki, Handa-city (JP); Shinji Makita, Ichinomiya-city (JP); Akito Akimoto, Kariya-city (JP); Kenichi Kita, Handa-city (JP); Tomokazu Nakamura, Nagoya-city (JP)

Correspondence Address: HARNESS, DICKEY & PIERCE, P.L.C., P.O. BOX 828, BLOOMFIELD HILLS, MI, 48303, US

(21) Appl. No.: 10/826,202

(22) Filed: Apr. 16, 2004

(30) Foreign Application Priority Data
Apr. 18, 2003 (JP) 2003-114939
Mar. 18, 2004 (JP) 2004-078249

(51) Int. Cl. H01F 27/28

(52) U.S. Cl. 336/180

(57) ABSTRACT

A wound coil member alternately includes first ring layers and second ring layers in a row. The first ring layer is formed in a manner that a coil wire is concentrically and inwardly wound by the given number of turns. By contrast, the second ring layer is formed in a manner that the coil wire is concentrically and outwardly wound by the certain number of turns. Here, a portion of the coil wire that transfers between the first ring layers and second ring layers does not cross over, but only runs upon any adjacent portions of the coil wire. As a result, even after the wound coil member is compressed, the compressed coil member does not easily involve a local deformation. Breakage of the coil wire, reduction of the cross sectional area, or damage of the coating can be thereby restricted.

### CROSS REFERENCE TO RELATED APPLICATIONS

This application is based on and incorporates herein by reference Japanese Patent Applications No. 2003-114939 filed on Apr. 18, 2003 and No. 2004-78249 filed on Mar. 18, 2004.

### FIELD OF THE INVENTION

The present invention relates to a coil member, its manufacturing method and system, a tooth member that the coil member is attached to, a core including the coil member and tooth member, and a rotary electric machine.

### BACKGROUND OF THE INVENTION

Conventionally, wound coil members are proposed to be formed by compression (refer to Patent documents 1, 2) or by using coil wires having polygonal sectional areas (refer to Patent document 3) so as to increase its space factor. Here, the space factor (or filling ratio) is a ratio of a cross sectional area of a conductive member (or turns of coil wire) with respect to a cross sectional area of a containing section when the conductive member is disposed in the containing section. As shown in FIGS. 10A, 10B, 10C, each of these conventional coil members 100 includes several hollow cylindrical portions 103 of coil wires 102. Each of the cylindrical portions 103 extends along an axis direction of a tooth member 101 or the coil member 100; the hollow cylindrical members 103 are aligned from the inside to the outside concentrically to the axis of the tooth member 101 or coil member 100.

In this winding method, a portion where the coil wires 102 are mutually crossing over (crossing-over portion) is generated at a portion of the coil wire 102 which intermediates between an end of a certain hollow cylindrical portion 103 and a start of an outwardly adjacent hollow cylindrical portion 103. The crossing-over portion thereby undergoes a local deformation when the wound coil member 100 is compressed. As a result, the coil wire 102 suffers wire breakage, damage of its coating, or reduction of the cross sectional areas. Using this kind of the compressed coil to various electric machines such as rotary electric machines results in reduction of the performance of the machines.

Patent document 1: JP-S434366 (Pages 1 to 6, FIG. 1), USP 3,348,183

Patent document 2: JP-A-S56-157232 (Pages 1 to 2, FIG. 4)

Patent document 3: JP-A-2000-197294 (Pages 3 to 8, FIG. 4)

### SUMMARY OF THE INVENTION

It is an object of the present invention to provide a wound coil member, its manufacturing method and system, a tooth member that the coil member is attached to, a core including the wound coil member and tooth member, and a rotary electric machine, in all of which compression forming does not easily involve wire breakage, damage of its coating, or reduction of the cross sectional areas.

To achieve the above object, a wound coil member is provided with the following. A plurality of first ring layers and a plurality of second ring layers are formed. Each of the first ring layers is formed so that a coil wire is wound by a given number of turns concentrically and inwardly. Each of the second ring layers is formed so that the coil wire is wound by a certain number of turns concentrically and outwardly. Here, the first ring layers and the second ring layers are alternately aligned in a row. In this structure, a portion of the coil wire that transfers between the first ring layers and second ring layers does not cross over, but only runs upon any adjacent portions of the coil wire. By contrast, in a conventional winding method, portions of the coil wire mutually cross over. As a result, even after the wound coil member is compressed, the compressed coil member does not easily involve a local deformation. Breakage of the coil wire, reduction of the cross sectional area, or damage of the coating can be thereby restricted.

In another aspect of the present invention, a tooth member is provided with the following. A tooth member is attached, perpendicularly to an axis direction of a rotary electric machine, inside a hollow cylinder defining an outer periphery of the rotary electric machine. An iron core included in the tooth member is a dual trapezoid shape. The dual trapezoid shape includes a first, second, and third cross sectional areas. The first cross sectional area is perpendicular to the axis direction of the rotary electric machine, and is a trapezoid having two sides that are parallel with each other and perpendicular to the axis direction. The second cross sectional area is parallel with both of the axis direction and an attachment direction of the tooth member, and is a trapezoid having two sides parallel with the axis direction. The third cross sectional area is perpendicular to the attachment direction, and has constant planar dimensions regardless of positions of the attachment direction. This structure enables ends of the coil protruding towards the axis direction of the rotary electric machine to be eliminated.

In yet another aspect of the present invention, a wound coil manufacturing system is provided with the following. A primary axis section is provided. A coil wire is continuously fed into the primary axis section making contact with the coil wire. An oscillating section is provided for oscillating in a circular arc, and facing the primary axis section via the coil wire. Here, a curvature of the coil wire is varied by sandwiching the coil wire between the primary axis section and the oscillating section and by oscillating the oscillating section. This structure enables a wound coil member to be manufactured without using a winding tool. No coil wire is partially unwound owing to elastic deformation generated after manufacturing the wound coil member, enabling a wound coil member having a non-circular inner surface to be manufactured.

### BRIEF DESCRIPTION OF THE DRAWINGS

The above and other objects, features, and advantages of the present invention will become more apparent from the following detailed description made with reference to the accompanying drawings. In the drawings:

FIGS. 1A, 1B, 1C are views for showing a wire winding method for a wound coil member according to a first embodiment of the present invention;

FIG. 2A is a view showing a start and end of winding of a coil member according to a related art;

FIG. 2B is a view showing a start and end of winding of a coil member according to the first embodiment;

FIG. 3 is views showing manufacturing methods of a wound coil member, a compressed coil member, a core, and a stator according to the first embodiment;

FIG. 4A is a first cross sectional view of a tooth member according to a second embodiment of the present invention;

FIG. 4B is a second cross sectional view of the tooth member according to the second embodiment;

FIG. 4C is a first cross sectional view of a tooth member according to a related art;

FIG. 4D is a second cross sectional view of the tooth member according to the related art;

FIG. 5 is views showing manufacturing methods of a wound coil member, a compressed coil member, a core, and a stator according to the second embodiment;

FIG. 6A is a view of a first sectional area of a tooth member according to a third embodiment of the present invention;

FIG. 6B is a cross sectional view taken from line VIB-VIB in FIG. 6A;

FIG. 7 is a plan view showing main parts of a system for manufacturing a wound coil member according to a fourth embodiment of the present invention;

FIG. 8 is a side view showing main parts of a system for manufacturing a wound coil member according to the fourth embodiment of the present invention;

FIG. 9 is a diagram showing a time series behavior of a turn angle of an oscillating section according to the fourth embodiment; and

FIG. 10A, 10B, 10C are views for showing a wire winding method for a wound coil member according to a related art.

### DETAILED DESCRIPTION OF THE PREFERRED EMBODIMENTS

### First Embodiment

Structure of First Embodiment

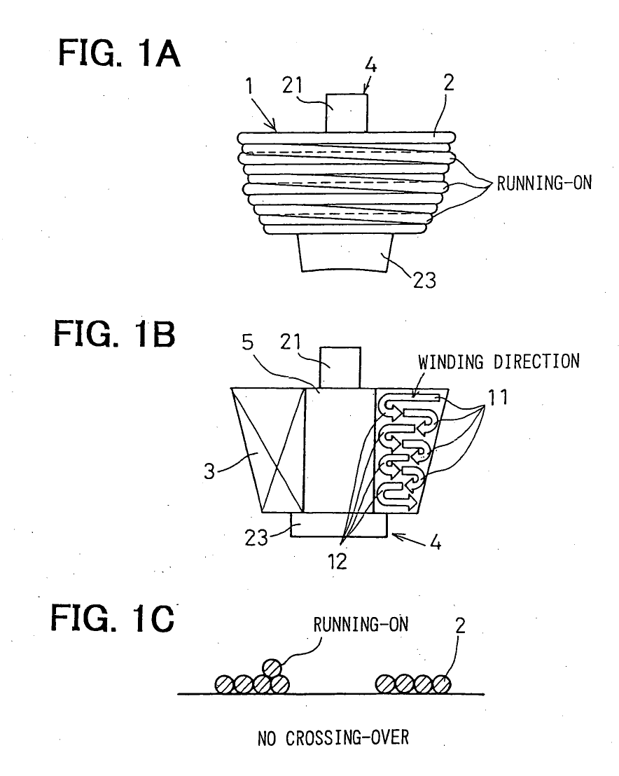

A structure of a wound coil member 1 according to a first embodiment of the present invention will be explained below, with reference to FIGS. 1A, 1 B, 1C, 2A, 2B, 3. The wound coil member 1 is manufactured by winding a coil wire 2; the wound coil member 1 then undergoes compression forming or the like to form a compressed coil member 3. The compressed coil member 3 is then attached to an iron core 5 of a tooth member 4, constituting a core 6 of a rotary electric machine. The core 6 is used, for instance, as a magnetic field pole of a direct current motor. Here, the compressed coil member 3 is used for a magnetic field coil that is provided with a magnetic field current.

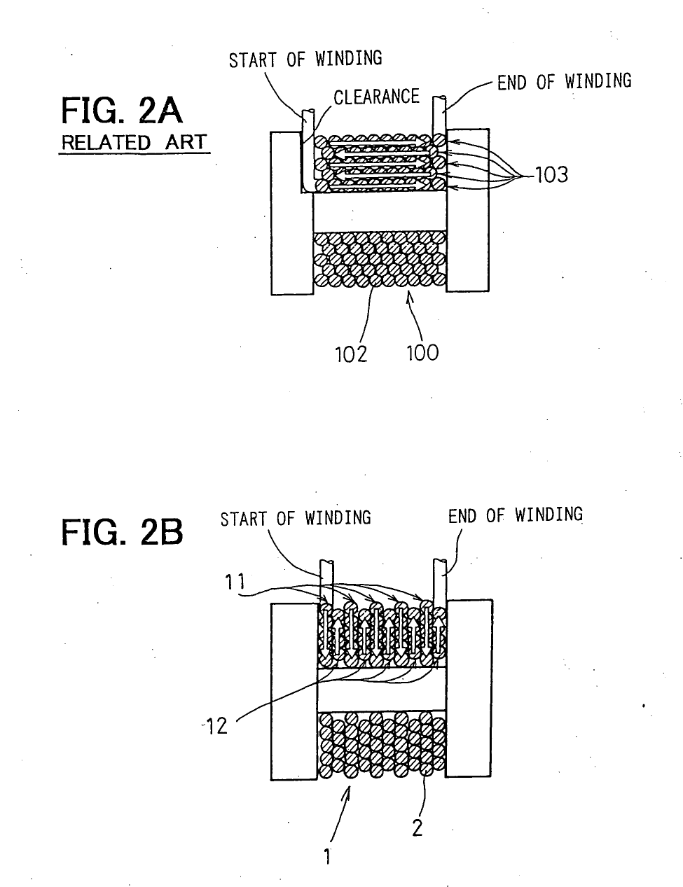

As shown in FIG. 2B, the wound coil member 1 includes multiple first ring layers 11 and second ring layers 12. The first layer is formed by winding a coil wire 2 by the given number of turns concentrically and inwardly, i.e., from an outer portion to an inner portion of the wound coil member 1, while the second is formed by the certain number of the turns concentrically and outwardly, i.e., from an inner portion to an outer portion. The first ring layers 11 and the second ring layers 12 are alternately aligned in a row in an axis direction of the wound coil member 1 as shown in FIG. 2B. Furthermore, the number of first ring layers is the same as the number of second ring layers. The winding start of the coil wire and winding end of the coil wire appear at outer perimeter portions of the wound coil member 1.

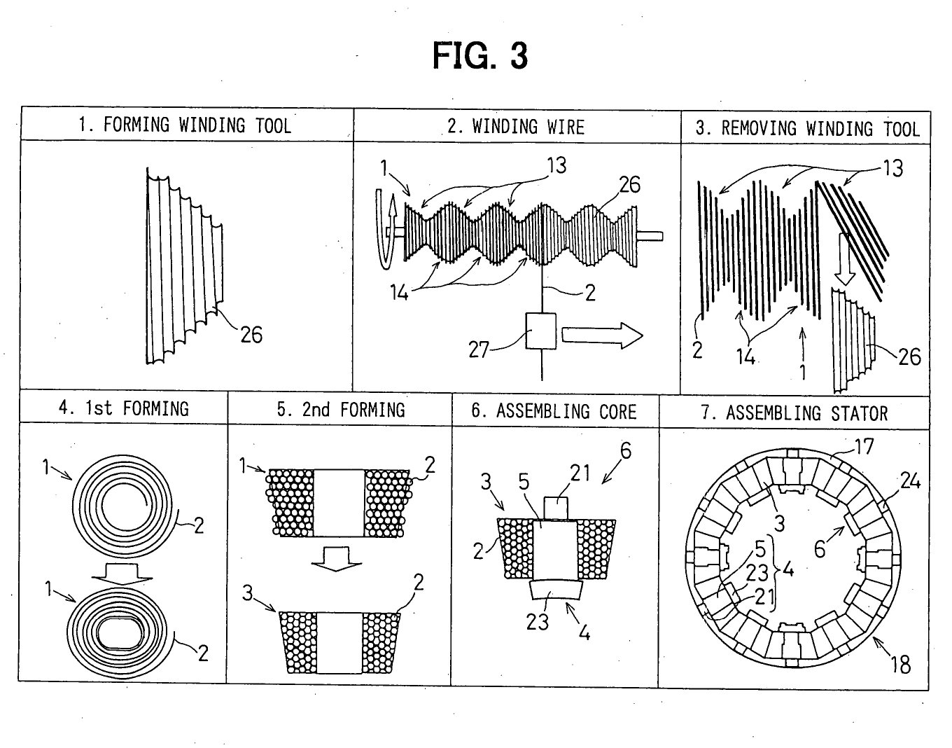

With respect to the first ring layer 11, a first helical portion 13 (shown in FIG. 3) is at first formed by winding the coil wire 2 inwardly (from an outer portion to an inner portion); the first helical portion 13 is then deformed to become a layer, i.e., the first ring layer 11. By contrast, with respect to the second ring layer 12, a second helical portion 14 (shown in FIG. 3) is at first formed by winding the coil wire 2 outwardly (from an inner portion to an outer portion); the second helical portion 14 is then deformed to become a layer, i.e., the second ring layer 12. The inner diameter of the wound coil member 1 approximately accords with a target value owing to elastic deformation generated in the wound coil member 1 after the first and second helical portions 13, 14 are formed.

The teeth member 4 to which the compressed coil member 3 is attached, as a core 6, is inserted, perpendicularly to an axis direction of the rotary electric machine, within a core back 17 being a hollow cylinder constituting an outer periphery of the rotary electric machine, as shown in FIG. 3. A stator 18 of the rotary electric machine is thereby constructed. The teeth member 4 includes an attachment portion 21 for being attached to the core back 17, an iron core 5 into which the compressed coil member 3 is attached, and an end portion 23 for forming a gap with a rotor (not shown) of the rotary electric machine. Further, the tooth member 4 is attached to the core back 17 by mating an attachment hole 24 provided in the inner surface of the core back 17.

Manufacturing Method for First Embodiment

Referring to FIG. 3, a manufacturing method for a wound coil member 1, compressed coil member 3, core 6, and stator 18 of the first embodiment will be explained below. At first, manufacturing a winding tool 26 that a coil wire 2 is wound around will be explained. The winding tool 26 is manufactured by being processed to a helical shape using an NC lathe. Here, the NC lathe is a lathe having a numerical control function capable of automatically controlling various processing conditions.

The wound coil member 1 is formed by winding a coil wire 2 around the winding tool 26; thereafter, the wound coil wire 2 is unwound in part by elastic deformation. Therefore, the number of turns of the coil wire 2 decreases while an inner diameter increases; repeating winding the coil wire 2 is necessary for compensating the partially unwound amount. Accordingly, in consideration of unwinding in part (spring back) of the coil wire 2 in the wound coil member 1, the winding tool 26 is designed such that the inner diameter just posterior to the winding by the winding tool 26 becomes less than a target diameter. For instance, when the number of turns of the first layer 11 or second ring layer 12 is five to seven, the winding tool 26 is designed to increase the number of turns by 90 degrees of a turn per a layer (refer to FIG. 3 (FORMING WINDING TOOL)).

The coil wire 2 is wound by the winding tool 26 via a tension mechanism 27. The first and second helical portions 13, 14 are alternately wound; the numbers of first and second helical portions 13, 14 are equal to each other.

The first helical portion 13 is a portion where the coil wire 2 is wound in a helical shape outwardly (from an inner portion to an outer portion), while the second helical portion 14 is a portion where the coil wire 2 is wound in a helical shape inwardly (from an outer portion to an inner portion), as shown in FIG. 3 (WINDING WIRE). After the first and second helical portions 13, 14 are formed, the winding tool 26 is removed (refer to FIG. 3 (REMOVING WINDING TOOL)).

The first and second helical portions 13, 14 are then deformed to become the first and second ring layers 11, 12 constituting the wound coil member 1, which undergoes a preparatory forming (1st forming). The preparatory forming is for deforming the wound coil member 1 by applying force to at least one of the inner perimeter portion (or inner surface) and outer perimeter portion (or outer surface) such that the shape of inner perimeter portion of the wound coil member 1 becomes approximately equal to that of the iron core 5. In the preparatory forming of the first embodiment, the shape of inner perimeter portion is deformed from a circular shape to an approximately elliptic shape having straight lines being parallel with each other, while the shape of outer perimeter portion is deformed from a circular shape to an elliptic shape (refer to FIG.3 (1st FORMING)).

After the preparatory forming, the wound coil member 1 undergoes a compression forming (2nd forming) to become a compressed coil member 3. The compression forming is for deforming the wound coil member 1 so that the cross sectional area of the coil wire 2 becomes a polygonal shape by compressing (FIG. 3 (2nd FORMING)). The compressed coil 3 is attached to the iron core 5 of the tooth member 4 to assemble the core 6 (FIG. 3 (ASSEMBLING CORE)). The core 6 is attached to the core back 17; the stator 18 is thereby assembled (FIG. 3 (ASSEMBLING STATOR)).

Effect of First Embodiment

In the first embodiment, the wound coil member 1 includes the first ring layers 11 and second ring layers 12 that are alternately aligned in a row; the first ring layer 11 is formed by concentrically winding the coil wire 2 inwardly, i.e., from an outside to an inside, by the given number of turns while the second ring layer 12 is formed by concentrically winding the coil wire 2 outwardly, i.e., from an inside to an outside, by the certain number of turns.

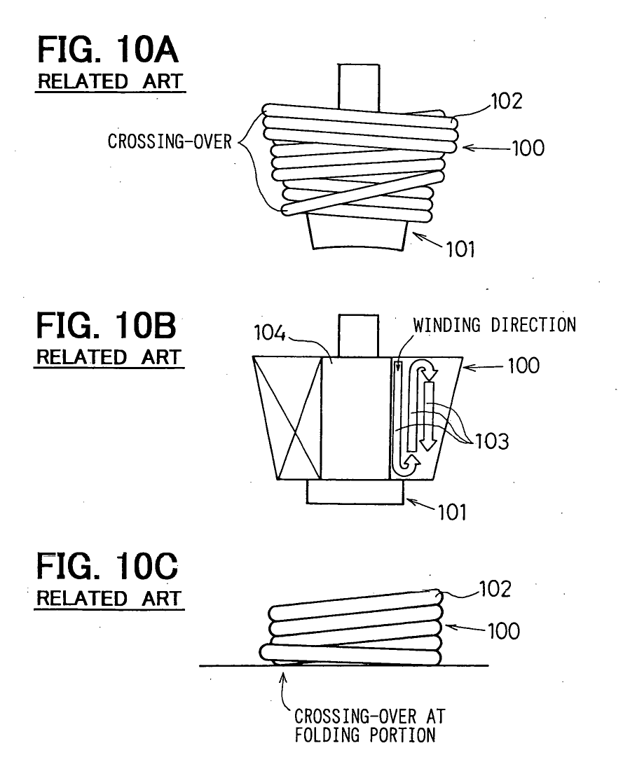

In this structure, a portion of the coil wire 2 between a certain ring layer 11, 12 and an adjacent ring layer 11, 12 only runs upon a portion of the coil wire 2 of the first or second ring layer 11, 12 as shown in FIGS. 1A, 1B. Therefore, no crossing-over portion where portions of the coil wire 2 are mutually crossing over is generated differently from the conventional winding method shown in FIG. 10A, 10C. Accordingly, even when the wound coil member 1 is processed by compression to the compressed coil member 3, local deformation is suppressed, which can restrict the breakage of the coil wire 2, the reduction of the cross sectional area of the coil wire 2, the damage of the coating of the coil wire 2, etc.

Further, the numbers of first and second ring layers 11, 12 are equal. The winding start and end can be thereby disposed at outer perimeters of the compressed coil member 3, as shown in FIG. 2B. The clearance necessary for the conventional winding method as shown in FIG. 2A can be eliminated.

Further, with respect to the first ring layer 11, the first helical portion 13 is at first formed by winding the coil wire 2 inwardly (from an outer portion to an inner portion); the first helical portion 13 is then deformed to become a layer, i.e., the first ring layer 11. By contrast, with respect to the second ring layer 12, a second helical portion 14 is at first formed by winding the coil wire 2 outwardly (from an inner portion to an outer portion); the second helical portion 14 is then deformed to become a layer, i.e., the second ring layer 12.

Using the helical winding tool 26 makes formation of the first and second helical portions 13, 14 easy. Therefore, forming the first and second ring layers 11, 12 from the first and second helical portions 13, 14, respectively, enables easy manufacturing of the wound coil member 1, which generates no crossing-over portions.

Further, the winding tool 26 is manufactured in consideration of the spring back of the wound coil member 1; the inner diameter of the wound coil member 1 can be approximately matched to the target value. This eliminates the need of repeating winding the coil wire 2 for compensating the turns unwound in part by the spring back, resulting in matching with the target value.

Further, the wound coil member 1 undergoes the preparatory forming prior to the compression forming, so that the shape of the inner perimeter portion becomes approximately equal to that of the iron core 5. This enables the wound coil member 1 to undergo the compression forming under the condition where the shape of the inner perimeter portion is approximately equal to that of the iron core 5. Accordingly, a slack of the coil wire 2 can be reduced in comparison with the case where the wound coil member 1 directly undergoes the compression forming without the preparatory forming. This results in increase of the space factor of the coil wire 2 in the compressed coil member 3.

### Second embodiment

Structure of Second Embodiment

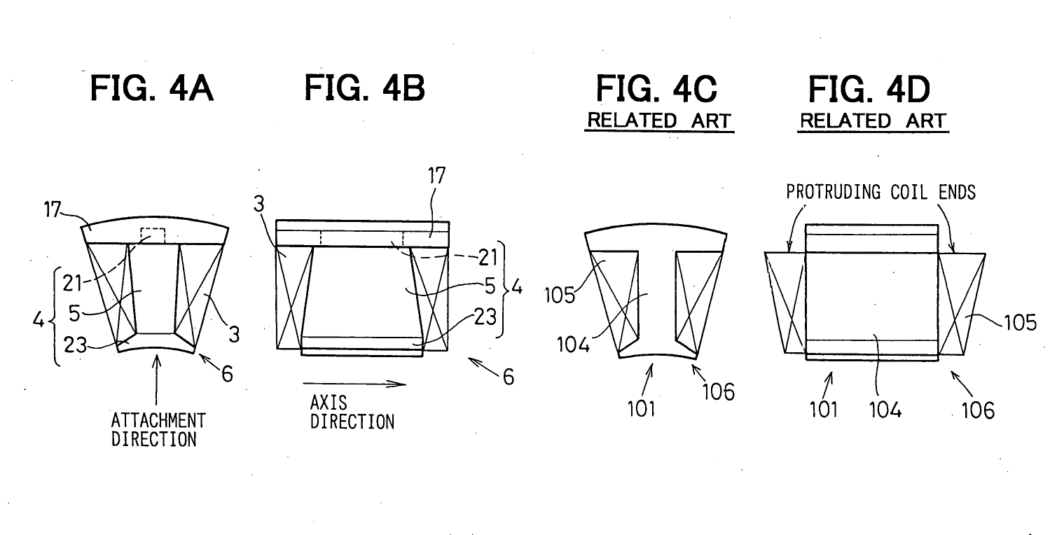

In a second embodiment of the present invention, as shown in FIGS. 4A, 4B, an iron core 5 of a tooth member 4 has a dual trapezoid shape. Namely, of the iron core 5, a first cross sectional area perpendicular to an axis direction of the rotary electric machine is a trapezoid having two sides that are parallel with each other and perpendicular to the axis direction (refer to FIG. 4A); a second cross sectional area parallel with both of the axis direction of the rotary electric machine and the attachment direction of the tooth member 4 is a trapezoid having two sides parallel with the axis direction of the rotary electric machine (refer to FIG. 4B). Furthermore, a third cross sectional area perpendicular to the attachment direction has constant planar dimensions regardless of positions of the attachment direction. In addition, the teeth member 4 is made from magnetic powder material such as nickel-iron alloy, soft iron, silicon steel, nickel, cobalt, or the like.

Manufacturing Method of Second Embodiment

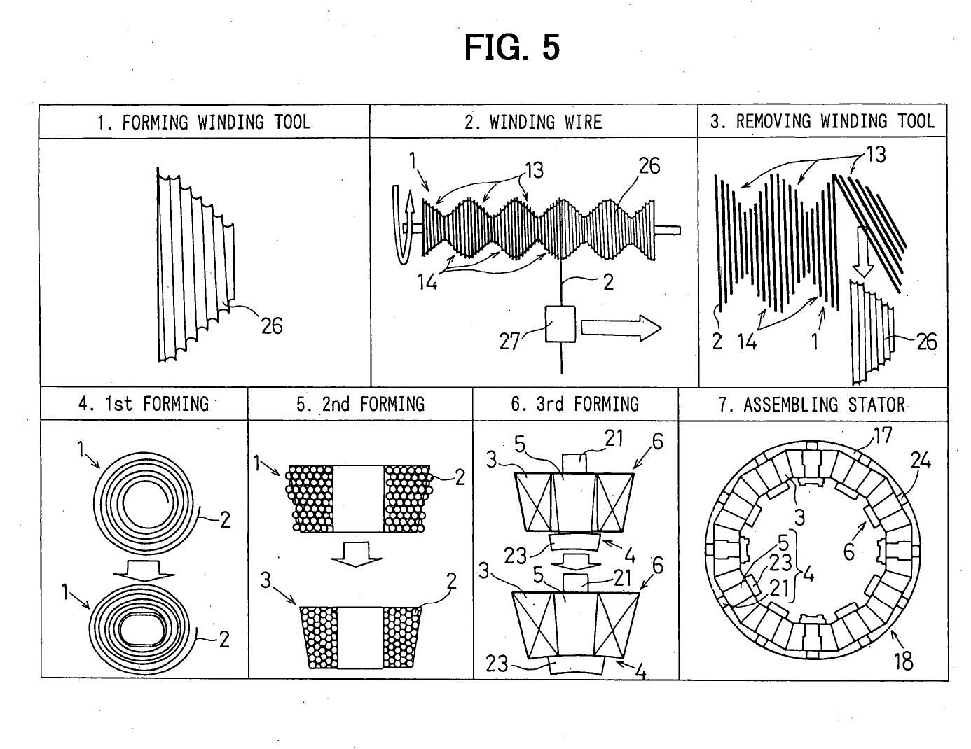

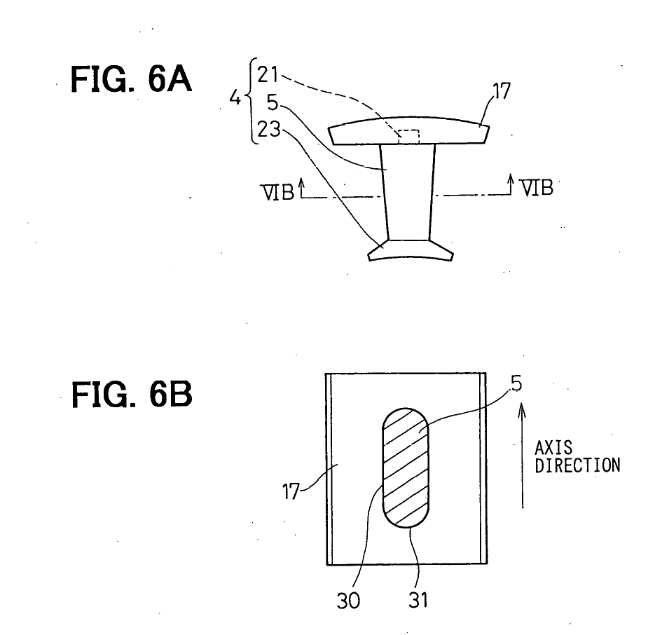

In the manufacturing method of the second embodiment, as shown in FIG. 5 (3rd FORMING), posterior to being attached to the tooth member 4, the compressed coil member 3 undergoes the third forming where the shape of the inner perimeter portion of the compressed coil member 3 is matched with the above-mentioned dual trapezoid shape of the iron core 5.

Effect of Second Embodiment

With respect to the iron core 5 of the second embodiment, the first cross sectional area perpendicular to an axis direction of the rotary electric machine is a trapezoid having two sides that are parallel with each other and perpendicular to the axis direction; the second cross sectional area parallel with both of the axis direction and the attachment direction of the tooth member 4 is a trapezoid having two sides parallel with the axis direction; furthermore, the third cross sectional area perpendicular to the attachment direction has constant planar dimensions regardless of positions of the attachment direction. Namely, the iron core 5 has a dual trapezoid shape.

By performing the third forming to the compressed coil member 3 attached to the tooth member 4, ends of the coil protruding towards the axis direction of the rotary electric machine can be eliminated. Namely, in the conventional rectangular shape iron core 104, the ends of the coil are considerably protruding when a compressed coil member 105 is attached to the iron core 104, as shown in FIGS. 4C, 4D. The length of the entire core 106 in the axis direction thereby becomes long. By contrast, in the iron core 5 of the dual trapezoid shape, the protruding ends of the coil cannot be generated, so that useless space occupied by the protruding ends of the coil can be eliminated, resulting in shortening the length of the rotary electric machine in the axis direction.

Furthermore, the tooth member 4 is formed by shaping the magnetic powder material. The conventional manufacturing method for the tooth member using a laminated plate cannot easily produce the dual trapezoidal iron core 5. By contrast, the manufacturing method using the magnetic powder shaping can easily produce the dual trapezoidal iron core 5.

### Third Embodiment

Structure of Third Embodiment

In a third embodiment, the third cross sectional area of an outer perimeter portion of an iron core 5 of the second embodiment has an additional feature. Namely, the third cross sectional area that is parallel with an axis direction of the rotary electric machine and perpendicular to an attachment direction of a tooth member 4 has a shape having two straight lines 30 parallel with the axis direction and curved lines 31 forming semicircles. By forming parts of the outer perimeter of the third cross sectional area that are curves, the outer perimeter of the iron core 5 becomes shorter than that of the iron core whose third cross sectional area is polygonal. This shortens the entire length of the coil wire 2, so that a consumed amount of the coil wire 2 can be decreased and electric resistance of the compressed coil member 3 can be decreased.

### Fourth embodiment

Structure of Fourth Embodiment

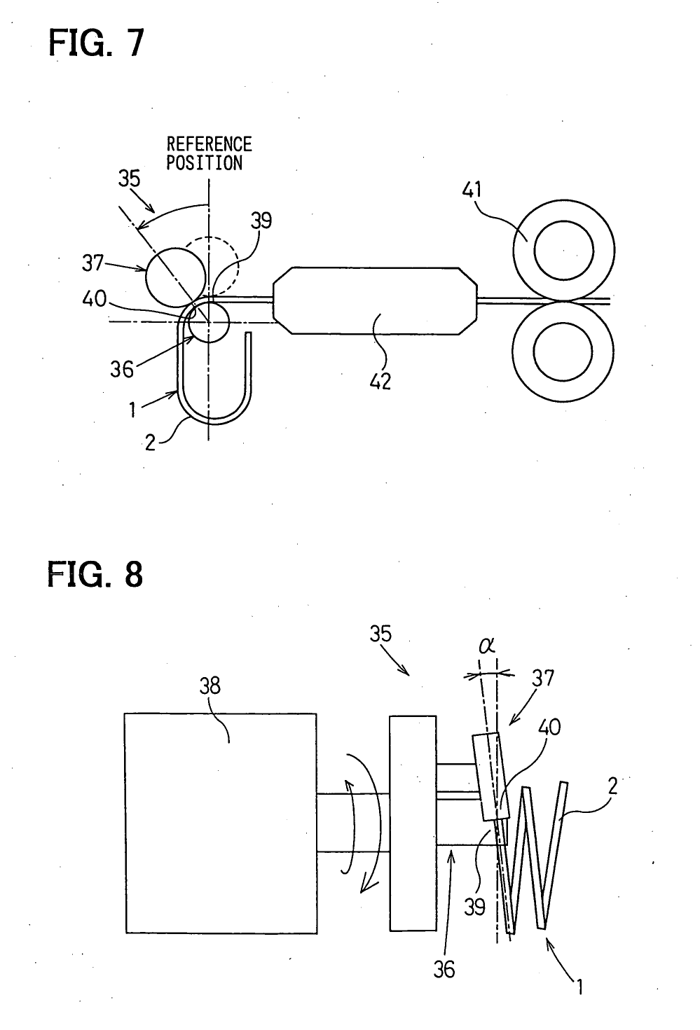

In a fourth embodiment, a wound coil member 1 is manufactured by a wound coil manufacturing system 35 shown in FIG. 7. The wound coil manufacturing system 35 includes a primary axis section 36 and an oscillating section 37. The primary axis section 36 of a round bar shape makes contact with a coil wire 2 that is continuously fed into the primary axis section 36. The oscillating section 37 of a circular disk shape is oscillated in a circular arc, sandwiching the coil wire 2 with the primary axis section 36. The oscillating section 37 is oscillated by being rotated with a central focus on the primary axis section 36 using a servo motor 38 as shown in FIG. 8. Further, outer peripheral surfaces of the primary axis section 36 and oscillating section 37 work as contact surfaces 39, 40 with the coil wire 2; the contact surface 40 of the oscillating section 37 faces, with inclination (an angle a), the contact surface 39 of the primary axis section 36. Here the angle a is ranged between two to five degrees.

Function of Fourth Embodiment

A function of the wound coil manufacturing system 35 of the fourth embodiment will be explained below. The coil wire 2 is continuously fed out by feed rollers 41; after misalignment in the feed direction is adjusted by a guide 42, the coil wire 2 is fed between the primary axis section 36 and oscillating section 37. The fed coil wire 2 is sandwiched between the primary axis section 36 and oscillating section 37, and a curvature of the coil wire 2 is continuously varied by oscillating the oscillating section 37. The coil wire 2 is thereby processed to a helical shape.

Further, the coil wire contact surface 40 of the oscillating section 37 is inclined with the angle α with respect to the coil wire contact surface 39 of the primary axis section 36. A driving force extruding the coil wire 2 in the axis direction of the primary axis section 36 is thereby generated when the coil wire 2 is fed between the two sections 36, 37 as shown in FIG. 8. As a result, after the curvature of the coil wire 2 is adjusted, the coil wire 2 is fed out in the axis direction of the primary axis section 36 with a pitch according to the angle α.

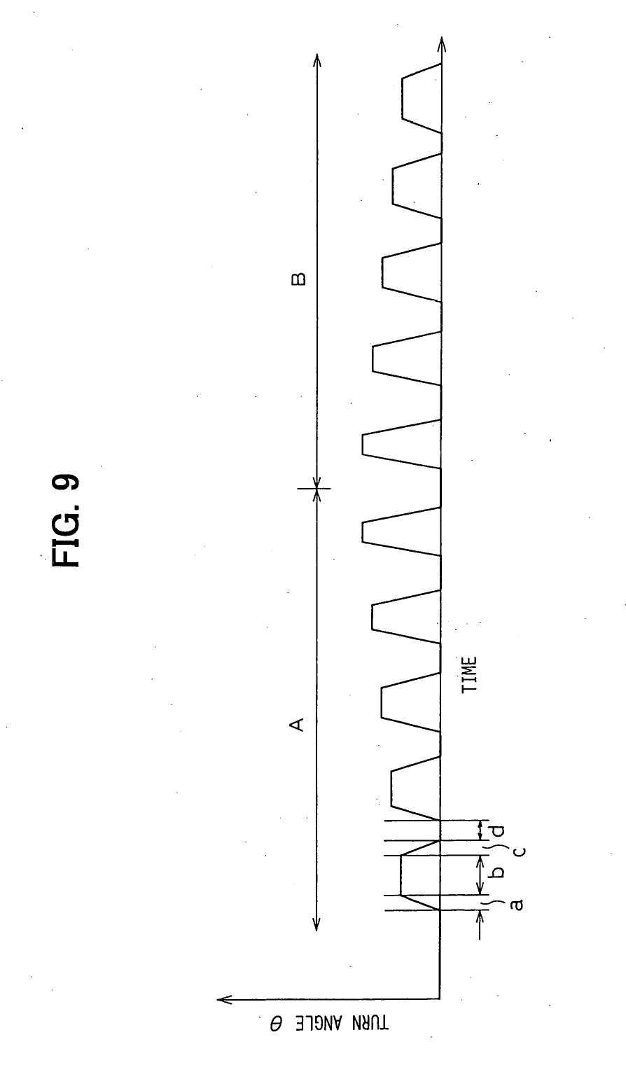

A turn angle θ of the oscillating section 37 from the reference position is varied with time, for instance, as shown in FIG. 9. Here, for instance, as shown in FIG. 9, the turn angle θ is changed to a preferable processing angle for a period a shown in FIG. 9 and is maintained at the preferable processing angle for a period b. This enables the coil wire 2 to be processed to have the curvature according to the processing angle. The turn angle θ is then changed to zero degree for a period c and is maintained at zero agree for a period d. This enables the coil wire 2 to be fed out in a straight shape. Hereinafter, these changes are repeated, so that the first and second helical portions 13, 14 of the wound coil member 3 are formed such as the portions 13, 14 are approximately matched with the third cross sectional area of the iron core 5 of the third embodiment. Further, the first helical portion 13 is formed for a period A for which the processing angle gradually increases, while the second helical portion 14 is formed for a period B for which the processing angle gradually decreases.

Effect of Fourth Embodiment

The wound coil manufacturing system 35 sandwiches the coil wire 2 between the primary axis section 36 and oscillating section 37, continuously adjusting the curvature of the coil wire 2 by oscillating the oscillating section 37. Thus, the wound coil member 3 is formed without using the winding tool 26. No spring back is generated after the wound coil member 1 is formed, so that a wound coil member 3 whose inner perimeter portion is non-circular can be manufactured. The wound coil member 3 can be manufactured such that the shape of the inner surface of the wound coil member 1 approximately accords with that of the non-circular iron core 5. Therefore, the slack of the coil wire 2 can be decreased without the preparatory forming; the space factor of the coil wire 2 can be increased.

Further, the coil wire contact surface 40 of the oscillating section 37 faces the coil wire contact surface 39 of the primary axis section 36 with the angle α. Therefore, after the curvature of the coil wire 2 is adjusted by the oscillating section 37, the coil wire 2 is fed out with the pitch in the axis direction of the primary axis section 36. As a result, the coil wire 2 whose curvature has been adjusted can be processed to the first and second helical portions 13, 14 without being interfered by oscillating of the oscillating section 37.

As described above, in this embodiment, a system for manufacturing an electromagnetic coil comprises a wire feeder and a wire bender. The wire feeder may be provided with a feed section including feed rollers 41 which propels the wire straight, and a guide section including a guide 42 which guides the wire along a feed direction of the wire feeder to keep the wire straight. By contrast, the wire bender applies a bending force on the wire fed from the guide 42. The wire bender is located on an outlet side of the wire feeder. The wire bender continuously bends the wire while the wire is running and releases the bent wire. Therefore, the wire bender, in other words, defines an outlet of the wire of which outlet direction is variable with respect to the feed direction of the wire feeder.

Further, the wire bender bends the wire in a predetermined inclination and a curvature. Due to the inclination and the curvature, the bent wire released from the wire bender coils itself into a helical coil having a diameter corresponding to the curvature and extending in an axial direction of the helical coil defined by the inclination. The inclination is an angle defined between the output direction of the bent wire and a virtual plane perpendicular to the axial direction of the helical coil. Here, the virtual plane is also parallel with the feed direction of the wire feeder. The curvature may be varied from zero to a predetermined maximum curvature. For example, the curvature is adjusted at zero when forming a straight portion of a rectangular shaped helical coil.

In a preferred embodiment, the helical coil can keep its helical shape without an inner core member. But the helical coil may be supported by a guide member on its outside. The helical coil may be formed into a tube shape as described in the previous embodiment that has an alternately varied diameter. The diameter of the helical coil is alternately varied along the axial direction of the helical coil. In order to form the helical coil in such an alternating diameter shape, the wire bender includes a movable member. The movable member moves in an oscillating fashion to vary the curvature of the wire continuously. The movable member can be driven in an oscillating fashion by an electric motor or a pneumatic actuator by employing well known mechanism. Further, the movable member can be disposed with a given inclination, resulting in generation of the helical coil.

In the preferred embodiment, the wire bender may be provided by a couple of rollers which bend the wire from the wire feeder while running the wire with respect to the feed direction of the wire feeder or an extending direction of the wire. The rollers may be called as the primary axis section 36 and an oscillating section 37. The oscillating section 37 works as a movable member to define a curvature of bent wire by moving its center around the primary axis section 36. In other words, the oscillating section 37 varies an angle of the wire wound on the primary axis section 36. Alternatively, the wire bender may be provided with a wall member located on an outlet of the guide 42 so that the wire fed from the outlet is obstructed on the wall member and is directed toward a predetermined direction while bending with a curvature. In this case, an angle of the wall member is varied to adjust and oscillate the curvature of the wire.

The system further comprises an axial compressing stage, a deforming stage, and an assembling stage. The helical coil released from the wire bender is cut at a predetermined length. Then, the helical coil is brought into the axial compressing stage. In the axial compressing stage, the helical coil is compressed in the axial direction. Preferably, the helical coil is compressed into a cylindrical shape formed with a plurality of turns of the wire. The turns form a plurality of axially stacked disk shaped rows. Each row includes radially aligned turns of the wire. The compressed coil may be called as a radial wound coil. The wire seems to be wound alternately in outward and inward in the compressed coil. Then, the compressed coil is brought to the deforming stage. In the deforming stage, the compressed coil is further compressed to deform a cross sectional shape of the wire in order to decrease and squeeze spaces defined between adjacent wire portions. For example, a round shaped wire may be deformed into a polygonal shape. Simultaneously, the external shape of the coil may be deformed to fit into a rotary electric machine. For example, the external shape of the coil is deformed into a trapezoidal shape. Due to a difference of compression ratio caused by the external shape of the coil, only a part of the wire is deformed in a cross section. Finally, the coil is assembled into a rotary electric machine. For example, the coil is mounted on a tooth member which is a part of a stator core of an electric motor.

### Modification

In this embodiment, the wound coil member 1 is used for the rotary electric machine; however, it can be also used for electrical transformers, reactors in other various electric devices. Further, in the fourth embodiment, the primary axis section 36 and oscillating section 37 are driven by the single servo motor 38; however, they can be separately assembled or they can be stationary without being rotated.

It will be obvious to those skilled in the art that various changes may be made in the above-described embodiments of the present invention. However, the scope of the present invention should be determined by the following claims.

What is claimed is:

1. A wound coil member comprising:
a plurality of first ring layers, each of which is formed so that a wire is wound by a given number of turns concentrically and inwardly; and
a plurality of second ring layers, each of which is formed so that the wire is wound by a certain number of turns concentrically and outwardly,
wherein the first ring layers and the second ring layers are alternately aligned in a row.

2. The wound coil member of claim 1,
wherein a number of first ring layers is equal to a number of second ring layers.

3. The wound coil member of claim 1,
wherein the first ring layer is formed by deforming a first helical portion to form a layer, wherein the first helical portion is formed so that the wire is wound inwardly in a helical shape, and
wherein the second ring layer is formed by deforming a second helical portion to form a layer, wherein the second helical portion is formed so that the wire is wound outwardly in a helical shape.

4. The wound coil member of claim 3,
wherein, owing to elastic deformation generated in the wound coil member after the first and second helical portions are formed, an inner diameter of the wound coil member approximately accords with a target diameter.

5. A method for manufacturing a wound coil member, comprising steps of:
forming a plurality of first ring layers included in the wound coil member, where a wire is wound by a given number of turns concentrically and inwardly; and
forming a plurality of second ring layers included in the wound coil member, where the wire is wound by a certain number of turns concentrically and outwardly,
wherein the first ring layers and the second ring layers are alternately aligned in a row, and
wherein the wound coil member is deformed so that a shape of an inner surface of the wound coil member approximately accords with a shape of an iron core into which the wound coil member is attached.

6. A method for manufacturing a wound coil member, comprising steps of:
forming a plurality of first ring layers included in the wound coil member, where a wire is wound by a given number of turns concentrically and inwardly; and
forming a plurality of second ring layers included in the wound coil member, where the wire is wound by a certain number of turns concentrically and outwardly,
wherein the first ring layers and the second ring layers are alternately aligned in a row, and
wherein the wire is wound so that a shape of an inner surface of the wound coil member approximately accords with a shape of an iron core into which the wound coil member is attached.

7. A compressed coil member that is formed by compressing a wound coil member, the wound coil member comprising:
a plurality of first ring layers included in the wound coil member, each of which is formed so that a wire is wound by a given number of turns concentrically and inwardly; and
a plurality of second ring layers, each of which is formed so that the wire is wound by a certain number of turns concentrically and outwardly, wherein the first ring layers and the second ring layers are alternately aligned in a row,
the compressed coil member formed by compressing and deforming the wound coil member so that the wire has a polygonal cross sectional area.

8. A method for manufacturing a compressed coil member that is formed by compressing a wound coil member including:
a plurality of first ring layers, each of which is formed so that a wire is wound by a given number of turns concentrically and inwardly; and
a plurality of second ring layers, each of which is formed so that the wire is wound by a certain number of turns concentrically and outwardly, wherein the first ring layers and the second ring layers are alternately aligned in a row,
the method comprising:
a preparatory step of deforming the wound coil member so that a shape of an inner surface of the wound coil member approximately accords with a shape of an iron core into which the wound coil member is attached by applying force to at least one of an outer surface and an inner surface of the wound coil member; and
a compression step of compressing the wound coil so that the wire has a polygonal cross sectional area.

9. A tooth member that is attached, perpendicularly to an axis direction of a rotary electric machine, inside a hollow cylinder defining an outer periphery of the rotary electric machine, the tooth member comprising:
an iron core being a dual trapezoid shape that includes:
a first cross sectional area being perpendicular to the axis direction of the rotary electric machine, and being a trapezoid having two sides that are parallel with each other and perpendicular to the axis direction;
a second cross sectional area being parallel with both of the axis direction and an attachment direction of the tooth member, and being a trapezoid having two sides parallel with the axis direction; and
a third cross sectional area being perpendicular to the attachment direction, and having constant planar dimensions regardless of positions of the attachment direction.

10. The tooth member of claim 9,
wherein a perimeter of the third cross sectional area partially includes a curved line.

11. The tooth member of claim 9,
wherein the tooth member is manufactured by shaping magnetic powder material.

12. An electromagnetic coil manufacturing system for manufacturing an electromagnetic coil using a wire, the system comprising:
a wire feeder which feeds the wire straight; and
a wire bender located on an outlet side of the wire feeder, which bends the wire in a predetermined inclination and a curvature, and releases the wire with the curvature so as to form the wire into a helical coil, wherein
the wire bender includes a movable member which continuously varies the curvature of the wire by moving in an oscillating fashion so that the helical coil is formed with an alternating diameter along an axial direction of the helical coil.

13. The electromagnetic coil manufacturing system of claim 12, further comprising an axial compressing stage in which the helical coil is compressed in an axial direction of the helical coil to form an axially compressed coil.

14. The electromagnetic coil manufacturing system of claim 13, further comprising a deforming stage in which the axially compressed coil is further compressed to deform a cross-sectional shape of the wire in order to squeeze spaces therebetween.

15. The electromagnetic coil manufacturing system of claim 12, wherein the wire bender further includes:
a primary axis member into which the wire is continuously fed, wherein the primary axis member faces the movable member via the wire.

16. The electromagnetic coil manufacturing system of claim 15,
wherein a contact surface of the primary axis member that makes contact with the wire faces, with an inclination corresponding to the predetermined inclination, a contact surface of the movable member that makes contact with the wire so that the wire is bent with the predetermined inclination.

17. The wound coil member of claim 1,
wherein the wound coil member is manufactured by a wound coil manufacturing system that includes:
a wire feeder which feeds the wire straight; and
a wire bender located on an outlet side of the wire feeder, which bends the wire in a predetermined inclination and a curvature, and releases the wire with the curvature so as to form the wire into a helical coil,
wherein the wire bender includes a movable member which continuously varies the curvature of the wire by moving in an oscillating fashion so that the helical coil is formed with an alternating diameter along an axial direction of the helical coil.

18. The method of claim 8 for manufacturing a compressed coil member,
wherein the wound coil member that is compressed to form the compressed coil member is manufactured by a wound coil manufacturing system that includes:
a wire feeder which feeds the wire straght; and
a wire bender located on an outlet side of the wire feeder, which bends the wire in a predetermined inclination and a curvature, and releases the wire with the curvature so as to form the wire into a helical coil,
wherein the wire bender includes a movable member which continuously varies the curvature of the wire by moving in an oscillating fashion so that the helical coil is formed with an alternating diameter along an axial direction of the helical coil.

19. A core comprising:
a compressed coil member; and
a tooth member into which the compressed coil member is attached,
wherein the compressed coil member is formed by compressing and deforming a wound coil member so that a wire has a polygonal cross sectional area, the wound coil member including:
a plurality of first ring layers included in the wound coil member, each of which is formed so that the wire is wound by a given number of turns concentrically and inwardly; and
a plurality of second ring layers, each of which is formed so that the wire is wound by a certain number of turns concentrically and outwardly, wherein the first ring layers and the second ring layers are alternately aligned in a row, and
wherein the tooth member is attached, perpendicularly to an axis direction of a rotary electric machine, inside a hollow cylinder defining an outer periphery of the rotary electric machine, the tooth member including an iron core being a dual trapezoid shape that includes:
a first cross sectional area being perpendicular to the axis direction of the rotary electric machine, and being a trapezoid having two sides that are parallel with each other and perpendicular to the axis direction;
a second cross sectional area being parallel with both of the axis direction and an attachment direction of the tooth member, and being a trapezoid having two sides parallel with the axis direction; and
a third cross sectional area being perpendicular to the attachment direction, and having constant planar dimensions regardless of positions of the attachment direction.

20. A rotary electric machine comprising a core that includes:
a compressed coil member; and
a tooth member into which the compressed coil member is attached,
wherein the compressed coil member is formed by compressing and deforming a wound coil member so that a wire has a polygonal cross sectional area, the wound coil member including:
a plurality of first ring layers included in the wound coil member, each of which is formed so that the wire is wound by a given number of turns concentrically and inwardly; and
a plurality of second ring layers, each of which is formed so that the wire is wound by a certain number of turns concentrically and outwardly, wherein the first ring layers and the second ring layers are alternately aligned in a row, and
wherein the tooth member is attached, perpendicularly to an axis direction of the rotary electric machine, inside a hollow cylinder defining an outer periphery of the rotary electric machine, the tooth member including an iron core being a dual trapezoid shape that includes:
a first cross sectional area being perpendicular to the axis direction of the rotary electric machine, and being a trapezoid having two sides that are parallel with each other and perpendicular to the axis direction;
a second cross sectional area being parallel with both of the axis direction and an attachment direction of the tooth member, and being a trapezoid having two sides parallel with the axis direction; and
a third cross sectional area being perpendicular to the attachment direction, and having constant planar dimensions regardless of positions of the attachment direction.
